(19) United States
(12) Patent Application Publication
(10) Pub. No.: US 2026/0001018 A1
(43) Pub. Date: Jan. 1, 2026

(54) POROUS COMPLEX AND METHOD OF PRODUCING POROUS COMPLEX

(71) Applicant: NGK INSULATORS, LTD., Nagoya-Shi (JP)

(72) Inventors: Yunie IZUMI, Nisshin-Shi (JP); Kenichi HIDAKA, Nagoya-Shi (JP); Mimika NOGUCHI, Ichinomiya-Shi (JP); Akihiro MIURA, Nagoya-Shi (JP)

(73) Assignee: NGK INSULATORS, LTD., Nagoya-Shi (JP)

(21) Appl. No.: 19/321,392

(22) Filed: Sep. 8, 2025

Related U.S. Application Data
(63) Continuation of application No. PCT/JP2024/011001, filed on Mar. 21, 2024.

(30) Foreign Application Priority Data
Mar. 29, 2023 (JP) 2023-053027

(51) Int. Cl. B01D 39/20; B01D 46/24; F01N 3/022

(52) U.S. Cl. CPC B01D 39/2093; B01D 46/2429; B01D 46/24491; B01D 46/24492; B01D 46/2482; F01N 3/0222; B01D 2239/10; B01D 2239/1208; B01D 2239/1216; B01D 2239/1241; B01D 2279/30; F01N 2330/48

(57) ABSTRACT

A porous complex includes a base material that is a porous sintered body having air permeability, and a collection layer that is a sintered body provided on the base material and having air permeability, the collection layer exhibiting a dense foam network structure in a longitudinal section. The collection layer is formed by depositing and firing porous particles on the base material. This suppresses the penetration of the collection layer into pores of the base material and allows the porous complex to achieve high collection efficiency and low pressure loss.

### CROSS-REFERENCE TO RELATED APPLICATIONS

The present application is a continuation application of International Application No. PCT/JP2024/011001 filed on Mar. 21, 2024, which claims priority to Japanese Patent Application No. JP2023-53027 filed in the Japan Patent Office on Mar. 29, 2023. The contents of these applications are incorporated herein by reference in their entirety.

### TECHNICAL FIELD

The present invention relates to a porous complex and a method of producing a porous complex.

### BACKGROUND ART

Vehicles or the like equipped with a diesel engine or a gasoline engine include a filter that collects particulate matter contained in an exhaust gas. As one example of such a filter, a honeycomb filter is used, in which a porous honeycomb base material includes a plurality of cells, some of which have a mesh sealing part at their opening on the outflow side and the remaining ones of which have a mesh sealing part at their opening on the inflow side.

For example, the honeycomb filter disclosed in Japanese Patent Application Laid-Open No. 2012-200642 (Document 1) includes a porous collection layer provided on the inner surfaces of cells that have a mesh sealing part at their opening on the outflow side. The collection layer is configured by bonding or entanglement of a plurality of particles and includes, as these particles, flat plate-like particles. The honeycomb filter disclosed in Document 1 can suppress an increase in initial pressure loss and a rise in pressure loss when particulate matter is deposited thereon.

In the honeycomb filter disclosed in WO/2020/194681 (Document 2), the collection layers provided in predetermined cells have an arithmetical mean height, which indicates surface roughness, of greater than or equal to 0.1 μm and less than or equal to 12 μm and a mean membrane thickness of greater than or equal to 10 μm and less than or equal to 40 μm. This achieves a reduction in pressure loss and an improvement in the efficiency of collecting particulate matter.

For porous complexes configuring honeycomb filters, as described above, techniques for improving the efficiency of collecting particulate matter or the like while reducing pressure loss in order to improve fuel consumption are proposed. Since there is a tradeoff relationship between those effects, it is not easy to reduce pressure loss while achieving high collection efficiency. However, due to recent tightening regulations, there is demand for the ability to further balance a reduction in pressure loss and an improvement in collection efficiency.

### SUMMARY OF THE INVENTION

It is an object of the present invention to provide a porous complex with high collection efficiency and low pressure loss.

Aspect 1 of the present invention is a porous complex that includes a base material that is a porous sintered body having air permeability, and a collection layer that is a sintered body provided on the base material and having air permeability, the collection layer exhibiting a dense foam network structure in a longitudinal section.

According to Aspect 1 of the present invention, it is possible to provide a porous complex with high collection efficiency and low pressure loss.

Aspect 2 of the present invention is the porous complex according to Aspect 1, in which the collection layer has a porosity of higher than or equal to 75% and lower than or equal to 95% and a mean pore diameter of greater than or equal to 0.3 μm and less than or equal to 1.5 μm.

Aspect 3 of the present invention is the porous complex according to Aspect 1 (or according to Aspect 1 or 2), in which the base material has a mean pore diameter of greater than or equal to 10 μm and less than or equal to 30 μm.

Aspect 4 of the present invention is the porous complex according to Aspect 1 (or according to any one of Aspects 1 to 3), in which the collection layer has a mean membrane thickness of greater than or equal to 20 μm and less than or equal to 45 μm.

Aspect 5 of the present invention is the porous complex according to Aspect 1 (or according to any one of Aspects 1 to 4), in which the collection layer is formed of alumina.

Aspect 6 of the present invention is the porous complex according to Aspect 1 (or according to any one of Aspects 1 to 5), in which the collection layer contains silicon carbide, and the base material is cordierite.

Aspect 7 of the present invention is the porous complex according to any one of Aspects 1 to 6, the porous complex being a particulate filter that collects particulate matter contained in an exhaust gas exhausted from a gasoline engine or a diesel engine.

Aspect 8 of the present invention is a method of producing a porous complex that includes a) generating an aggregate of intermediate particles by drying droplets that contain pore-forming materials and material particles smaller than the pore-forming materials, the intermediate particles being particles where the material particles are present between the pore-forming materials that are densely gathered, b) forming a porous intermediate by pre-firing the aggregate of the intermediate particles, c) obtaining porous particles by disintegration of the porous intermediate, d) preparing a base material that is a porous sintered body having air permeability, e) depositing the porous particles on the base material, and f) forming a collection layer on the base material by firing the porous particles.

Aspect 9 of the present invention is the method of producing a porous complex according to Aspect 8, in which the pore-forming materials have a mean particle diameter of greater than or equal to 500 nm and less than or equal to 10 μm, and the material particles have a specific surface area of higher than or equal to 150 m2/g and lower than or equal to 400 m²/g or a mean particle diameter of greater than or equal to 10 nm and less than or equal to 50 nm.

Aspect 10 of the present invention is the method of producing a porous complex according to Aspect 8 (or according to Aspect 8 or 9), in which the base material has a mean pore diameter of greater than or equal to 10 μm and less than or equal to 30 μm, and the porous particles have a mean particle diameter of greater than or equal to 15 μm and less than or equal to 40 μm.

Aspect 11 of the present invention is the method of producing a porous complex according

to Aspect 10, in which in the operation e), the porous particles are deposited to a thickness of greater than or equal to 25 μm and less than or equal to 50 μm on the base material.

Aspect 12 of the present invention is the method of producing a porous complex according to any one of Aspects 8 to 11, in which the material particles are alumina particles.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a plan view showing a porous complex in simplified form.

FIG. 2 is a sectional view showing part of the porous complex.

FIG. 3 shows a SEM image of a longitudinal section of the porous complex that includes a collection layer.

FIG. 4 is a diagram showing part of FIG. 3 in enlarged dimensions.

FIG. 5 is a simplified diagram of the structure shown in FIG. 3.

FIG. 6 shows a SEM image of a longitudinal section of a collection layer according to a comparative example in enlarged dimensions.

FIG. 7 shows a SEM image of a state in which the collection layer penetrates into a base material.

FIG. 8 is a flowchart showing the production of the porous complex.

FIG. 9A is a diagram showing a droplet that contains material particles and pore-forming materials.

FIG. 9B is a diagram showing an intermediate particle.

FIG. 9C is a diagram showing a porous intermediate.

FIG. 10 is a diagram showing a configuration of a dry deposition device.

FIG. 11 is a diagram for describing a state in which porous particles are deposited on the base material.

FIG. 12 is a diagram for describing the way of obtaining a mean membrane thickness.

### DETAILED DESCRIPTION

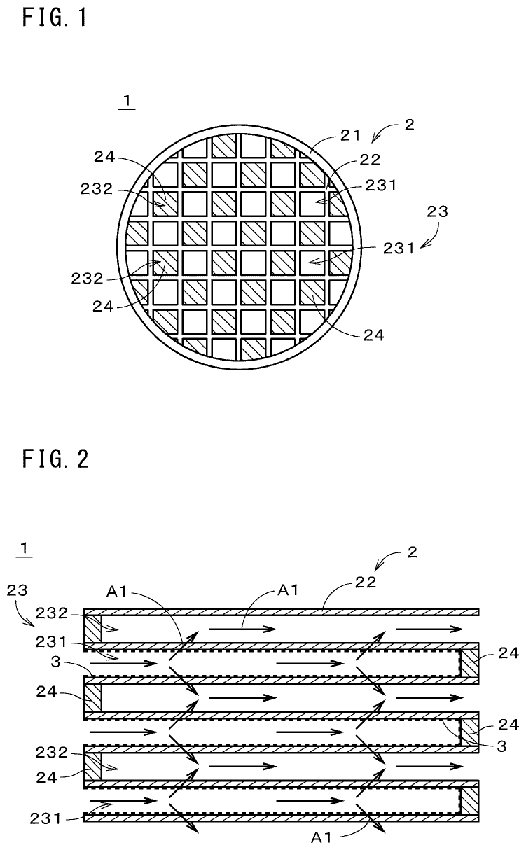

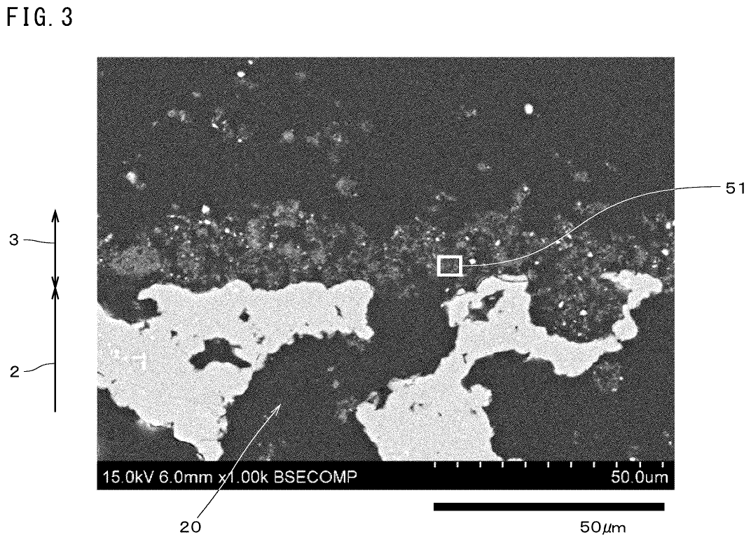

FIG. 1 is a plan view showing a porous complex 1 according to one embodiment of the present invention in simplified form. The porous complex 1 is a tubular member that is long in one direction, and FIG. 1 shows the end face of the porous complex 1 on one side in the longitudinal direction. FIG. 2 is a sectional view showing part of the porous complex 1. FIG. 2 shows part of a section along the longitudinal direction. The direction perpendicular to the plane of the drawing of FIG. 1 corresponds to the right-and-left direction in FIG. 2. For example, the porous complex 1 is used as a gasoline particulate filter (GPF) that collects particulate matter (i.e., fine particles) such as soot contained in an exhaust gas exhausted from a gasoline engine of an automobile or the like.

The porous complex 1 includes a base material 2 that is a porous sintered body, and a collection layer 3 that is a porous sintered body (see FIG. 2). In the example shown in FIGS. 1 and 2, the base material 2 is a member having a honeycomb structure. The base material 2 includes a tubular outer wall 21 and partition walls 22. The tubular outer wall 21 is a tubular portion that extends in the longitudinal direction (i.e., the right-and-left direction in FIG. 2). The tubular outer wall 21 may have, for example, an approximately circular sectional shape perpendicular to the longitudinal direction. This sectional shape may be any other shape such as a polygonal shape.

The partition walls 22 are a gird portion that is provided in the interior of the tubular outer wall 21 and partitions the interior into a plurality of cells. As will be described later, these cells include a plurality of first cells 231 and a plurality of second cells 232. In the following description, when there is no need to distinguish between the first cells 231 and the second cells 232, the first cells 231 and the second cells 232 are simply referred to as “cells 23”. Each of the cells 23 is a space that extends in the longitudinal direction. Each cell 23 has, for example, an approximately square sectional shape perpendicular to the longitudinal direction. This sectional shape may be any other shape such as a polygonal shape or a circular shape. As a general rule, the cells 23 have the same sectional shape. Alternatively, the cells 23 may include cells 23 that have different sectional shapes. The base material 2 is a cell structure whose interior is partitioned into the cells 23 by the partition walls 22.

The tubular outer wall 21 and the partition walls 22 are each a porous part. For example, the tubular outer wall 21 and the partition walls 22 are formed of ceramic such as cordierite. The materials for the tubular outer wall 21 and the partition walls 22 may also be ceramic other than cordierite, or may be a different material other than ceramic.

The tubular outer wall 21 has a longitudinal length of, for example, greater than or equal to 50 mm and less than or equal to 300 mm. The outside diameter of the tubular outer wall 21 is, for example, greater than or equal to 50 mm and less than or equal to 300 mm. The thickness of the tubular outer wall 21 is, for example, greater than or equal to 30 μm and preferably greater than or equal to 50 μm. The thickness of the tubular outer wall 21 is, for example, less than or equal to 1000 μm, preferably less than or equal to 500 μm, and more preferably less than or equal to 350 μm. The longitudinal length of the partition walls 22 is approximately the same as that of the tubular outer wall 21. The thickness of the partition walls 22 is, for example, greater than or equal to 30 μm and preferably greater than or equal to 50 μm. The thickness of the partition walls 22 is, for example, less than or equal to 1000 μm, preferably less than or equal to 500 μm, and more preferably less than or equal to 350 μm.

The porosity of the base material 2 including the tubular outer wall 21 and the partition walls 22 is, for example, higher than or equal to 20% and preferably higher than or equal to 30%. The porosity of the base material 2 is, for example, lower than or equal to 80% and preferably lower than or equal to 70%. The open porosity of the base material 2 is, for example, higher than or equal to 40% and preferably higher than or equal to 55%. The open porosity of the base material 2 is, for example, lower than or equal to 65%. The porosity and open porosity of the base material 2 can be measured by the Archimedes method.

A mean pore diameter of the base material 2 (an arithmetical mean value obtained by dividing a total value of the diameters of all pores by the number of pores, or a value equivalent thereto; the same applies below) is, for example, greater than or equal to 10 μm and preferably greater than or equal to 15 μm. The mean pore diameter of the base material 2 is, for example, less than or equal to 30 μm and preferably less than or equal to 25 μm. The mean pore diameter can be measured by a mercury porosimeter. The open area ratio of the surface of the base material 2 is, for example, higher than or equal to 20% and preferably higher than or equal to 25%. The open area ratio of the surface of the base material 2 is also, for example, lower than or equal to 60% and preferably lower than or equal to 50%. The open area ratio of the surface refers to the proportion of the area of a region where pores are open in the surface of the base material 2 and can be obtained by image analysis of a SEM (scanning electron microscope) image of this surface. The SEM image is captured at, for example, 500× magnification. The image analysis may be conducted using, for example, image analysis software “Image-Pro ver. 9.3.2” manufactured by Nippon Roper K. K.

The cell density of the base material 2 (i.e., the number of cells 23 per unit area of a section perpendicular to the longitudinal direction) is, for example, higher than or equal to 10 cells/cm², preferably higher than or equal to 20 cells/cm², and more preferably higher than or equal to 30 cells/cm². This cell density is, for example, lower than or equal to 200 cells/cm² and preferably lower than or equal to 150 cells/cm². In FIG. 1, the cells 23 are illustrated larger than their actual size and smaller in number than their actual number. Features of the cells 23 such as size and number may be modified in various ways.

In the case where the porous complex 1 is used as a GPF, a gas such as an exhaust gas flows through the inside of the porous complex 1, with one longitudinal end side of the porous complex 1 (i.e., the left side in FIG. 2) serving as an inlet and the other longitudinal end side thereof as an outlet. Among the cells 23 of the porous complex 1, some cells 23 have a mesh sealing part 24 at their end on the inlet side, and the remaining cells 23 have a mesh sealing part 24 at their end on the outlet side.

FIG. 1 illustrates the inlet side of the porous complex 1. To facilitate understanding of the drawing, the mesh sealing parts 24 on the inlet side are cross-hatched in FIG. 1. In the example shown in FIG. 1, the cells 23 that have the mesh sealing part 24 on the inlet side and the cells 23 that do not have the mesh sealing part 24 on the inlet side (i.e., the cells 23 that have the mesh sealing part 24 on the outlet side) are alternately aligned in both the vertical and horizontal directions in FIG. 1.

The first cells 231 are cells 23 that have the mesh sealing part 24 on the outlet side. The second cells 232 are cells 23 that have the mesh sealing part 24 on the inlet side. In the porous complex 1, the first cells 231 sealed at one longitudinal end and the second cells 232 sealed at the other longitudinal end are arranged alternately.

The collection layer 3 is formed on the base material 2. In the example shown in FIG. 2, the collection layer 3 is provided in the first cells 231 having the mesh sealing part 24 on the outlet side, and covers the inner surfaces of the first cells 231 (i.e., the surface of the partition walls 22). The collection layer 3 is indicated by thick broken lines in FIG. 2. The collection layer 3 may also be provided on the inner surfaces of the mesh sealing parts 24 on the outlet side of the first cells 231. On the other hand, the collection layer 3 does not exist in the second cells 232 having the mesh sealing part 24 on the inlet side. In other words, the inner surfaces of the second cells 232 are exposed without being covered with the collection layer 3.

In the porous complex 1 shown in FIGS. 1 and 2, as indicated by arrows Al in FIG. 2, a gas introduced in the porous complex 1 flows into the first cells 231 from the inlets of the first cells 23 whose inlet side is not sealed, and flows from the first cells 231 through the porous collection layer 3 and the porous partition walls 22 into the second cells 232 whose outlet side is not sealed. At this time, the collection layer 3 efficiently collects substances to be collected (here, particulate matter) that are contained in the gas. In the case where the collection layer 3 contains catalyst particles that will be described later, combustion of collected particulate matter (i.e., removal by oxidation) is accelerated. In the following description, the inner surfaces of the first cells 231 provided with the collection layer 3 are also referred to as “collection surfaces”.

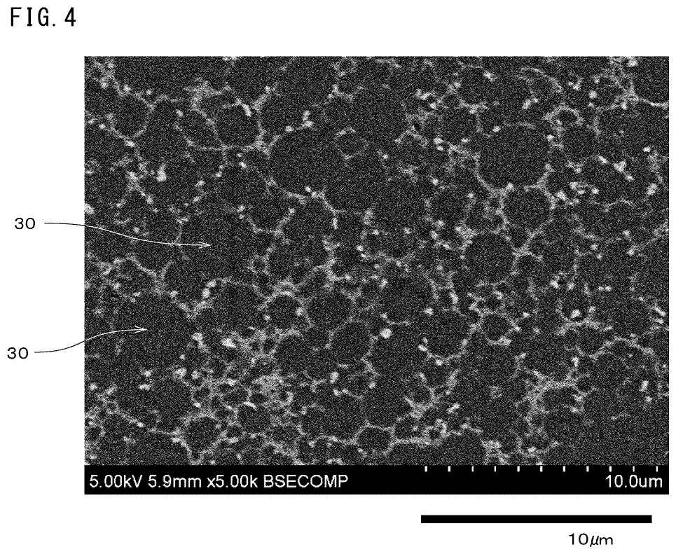

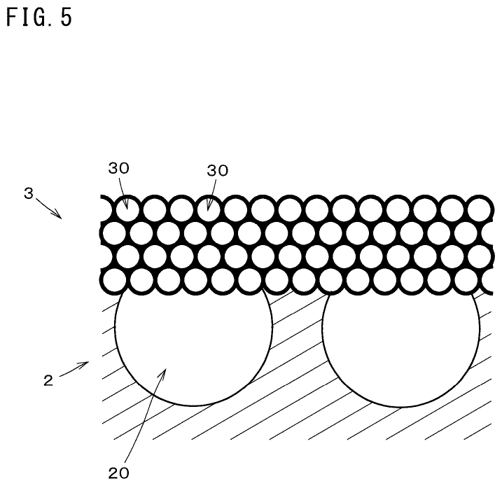

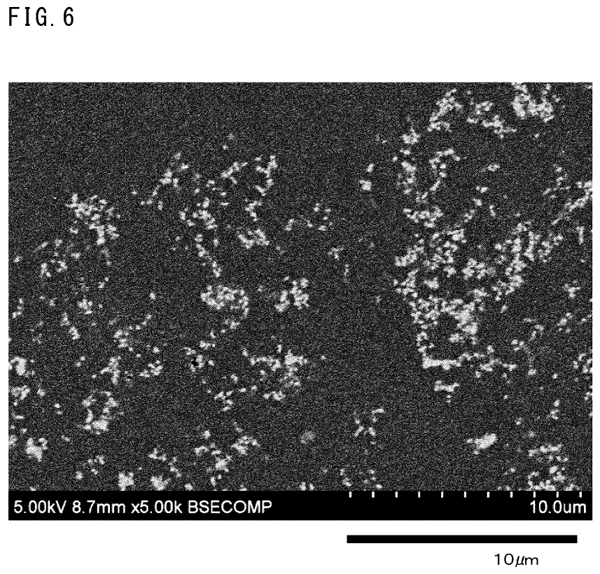

FIG. 3 shows a SEM image of a longitudinal section of the porous complex 1 provided with the collection layer 3. The “longitudinal section” refers to a plane perpendicular to the surface of the base material 2, and FIG. 3 shows a longitudinal section that is parallel to the longitudinal direction of the cells 23. In FIG. 3, the range indicated by the reference sign 2 indicates the range of the base material 2, and the range of a gray region indicated by the reference sign 3 indicates the range of the collection layer 3. The gray shadow seen above the collection layer 3 indicates a portion that has been separated from the collection layer 3 during preparation of a sample to be observed, and does not configure the collection layer 3. FIG. 4 shows a SEM image of a portion of the collection layer 3, indicated by a reference sign 51 shown in FIG. 3, in enlarged dimensions. FIG. 5 is a simplified diagram of the longitudinal sectional structure shown in FIG. 3.

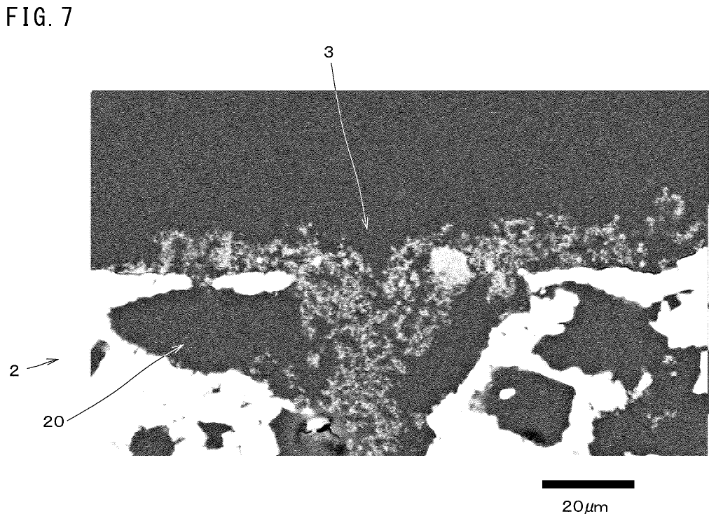

As shown in FIGS. 3 and 5, the base material 2 has large pores 20 and has air permeability because the pores 20 are connected to one another. The collection layer 3 is formed on the base material 2. As shown in FIG. 4, the collection layer 3 exhibits a dense foam network structure in a longitudinal section. The network structure is a structure in which alumina (Al₂O₃) is continuous in mesh form in three dimensions. The continuous form of alumina forms a continuous space in which a large number of approximately spherical spaces 30 are connected in part to one another. These spaces can also be regarded as spaces inside a sponge-like structure. In FIG. 5, the large number of spaces 30 are expressed as bold circles. Since both of the base material 2 and the collection layer 3 have air permeability, the porous complex 1 also has air permeability. A mean pore diameter of the collection layer 3 is smaller than the mean pore diameter of the base material 2. Although the method of forming the collection layer 3 will be described later, in the case where the collection layer is formed by simply attaching alumina particles to the base material 2 and firing the alumina particles, as shown in FIG. 6, the network structure as shown in FIG. 4 is not observed. Note that FIG. 3 corresponds to Example 1 described later, and FIG. 6 corresponds to Comparative Example 1 described later.

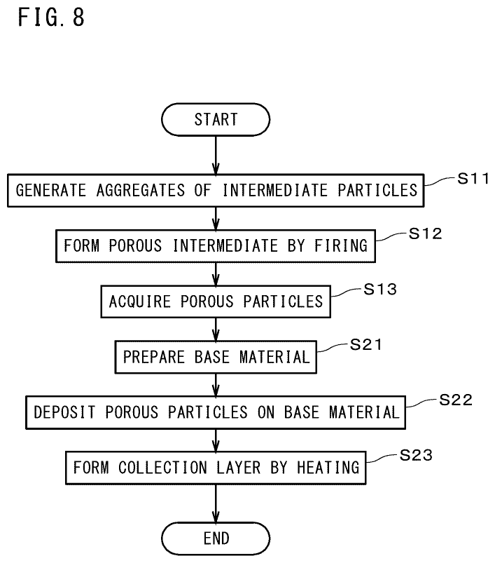

As shown in FIGS. 3 and 5, the collection layer 3 covers openings of the pores 20 of the base material 2, but does not penetrate into the pores 20. Conventionally, it was necessary to reduce the size of material particles of the collection layer in order to improve collection efficiency, but in this case, the material particles of the collection layer 3 penetrate into the pores 20, resulting in a considerable increase in pressure loss as shown in FIG. 7. If the collection layer is reduced in thickness in order to suppress an increase in pressure loss, collection efficiency will deteriorate. In contrast to this, the collection layer 3 shown in FIG. 3 does not penetrate into the pores 20, thus achieving satisfactory collection efficiency while suppressing an increase in pressure loss.

The collection layer 3 may include catalyst particles in order to accelerate removal of collected substances by oxidation. For example, the catalyst particles become part of the collection layer 3 by being attached to the collection layer 3 and subjected to baking. The aforementioned catalyst particles are typically an oxide and are preferably CeO₂ (ceria), a lanthanum (La)-cerium (Ce) composite oxide, a lanthanum-manganese (Mn)-cerium composite oxide, a lanthanum-cobalt (Co)-cerium composite oxide, a lanthanum-iron (Fe)-cerium composite oxide, or a lanthanum-praseodymium (Pr)-cerium composite oxide. In other words, it is preferable that the particles of the collection layer 3 contain one or more types of CeO₂, a lanthanum-cerium composite oxide, a lanthanum-manganese-cerium composite oxide, a lanthanum-cobalt-cerium composite oxide, a lanthanum-iron-cerium composite oxide, and a lanthanum-praseodymium-cerium composite oxide.

The lanthanum-cerium composite oxide is an oxide that contains La and Ce and also written as “La—Ce—O”. The lanthanum-manganese-cerium composite oxide is an oxide that contains La, Mn, and Ce and also written as “La—Mn—Ce—O”. The lanthanum-cobalt-cerium composite oxide is an oxide that contains La, Co, and Ce and also written as “La—Co—Ce—O”. The lanthanum-iron-cerium composite oxide is an oxide that contains La, Fe, and Ce and also written as “La—Fe—Ce—O”. The lanthanum-praseodymium-cerium composite oxide is an oxide that contains La, Pr, and Ce and also written as “La—Pr—Ce—O”.

Particles of the aforementioned composite oxides are produced by, for example, a citric acid method. The particles of the composite oxides may also be produced by any other method such as an impregnation supporting method or a complex polymerization method.

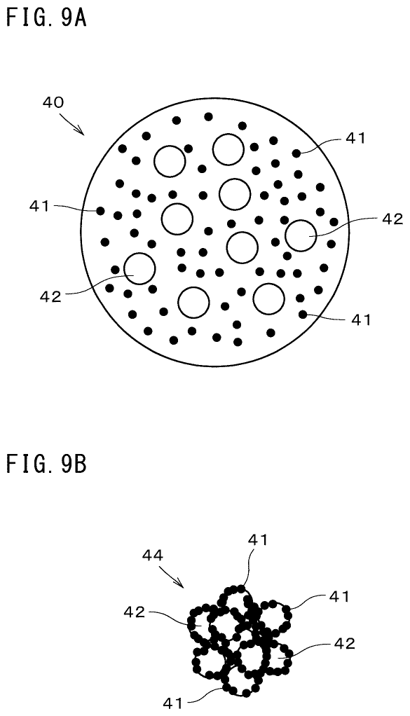

Next, one example of the production of the porous complex 1 will be described. FIG. 8 is a flowchart showing the production of the porous complex 1. The steps of producing the porous complex 1 are divided into the production of porous particles (steps S11 to S13) and the formation of the collection layer 3 (steps S21 to S23). In the production of porous particles, firstly, for example, pore-forming materials of polyethylene are mixed with an alumina sol that contains alumina particles (or colloidal silica that contains silica (SiO₂) particles), and aggregates of intermediate particles, i.e., dry powder, are acquired by a spray drying device (step S11).

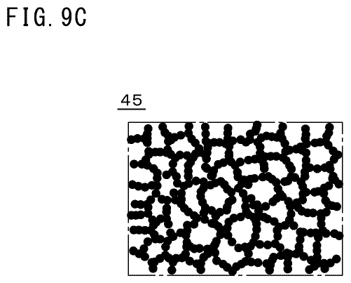

FIGS. 9A and 9B are diagrams schematically showing step S11. As shown in FIG. 9A, fine droplets 40 that contain alumina particles 41 (or silica particles; hereinafter, the same applies to steps S11 and S12) and particles 42 of a pore-forming material (hereinafter, simply referred to as the “pore-forming materials”) in a solvent (e.g., water) are sprayed into hot air by an atomizer, and these droplets 40 are dried. Since the alumina particles 41 are smaller enough than the pore-forming materials 42, the alumina particles 41 adhere to around the densely gathered pore-forming materials 42 as shown in FIG. 9B, forming intermediate particles 44. The intermediate particles 44 are considered to be configured such that the pore-forming materials 42 are gathered and the alumina particles 41 are present in the interstices between the pore-forming materials 42 (and further on the surfaces of the pore-forming materials 42). The aggregates of the intermediate particles 44 are obtained by spray drying.

Preferably, the material particles for forming the collection layer 3 are the aforementioned alumina particles or silica particles. The material particles may also be particles other than alumina or silica particles, and may be cordierite (2MgO.2Al₂O₃.5SiO₂) particles or mullite (3Al₂O₃.2SiO₂) particles and the like. It is preferable that the material particles have particle diameters of smaller enough than the particle diameters of the pore-forming materials.

Specifically, a mean particle diameter of the material particles is preferably less than or equal to 1/10 and greater than or equal to 1/1000 of a mean particle diameter of the pore-forming materials. The mean particle diameter of the pore-forming materials is preferably greater than or equal to 500 nm and less than or equal to 10 μm. In the case where the size of the material particles is identified by the specific surface area, the specific surface area is preferably greater than or equal to 150 m²/g and less than or equal to 400 m²/g. In the case where the size of the material particles is identified by the mean particle diameter, the mean particle diameter is preferably greater than or equal to 10 nm and less than or equal to 50 nm.

The aggregates of the intermediate particles 44 are subjected to pre-firing (step S12). That is, the aggregates of the intermediate particles 44 are heated to remove the pore-forming materials 42 by combustion, and the alumina particles 41 are bonded together to some extent to form a porous intermediate 45 shown in FIG. 9C. The porous intermediate 45 is subjected to disintegration and classification to acquire porous particles of desired dimensions (step S13).

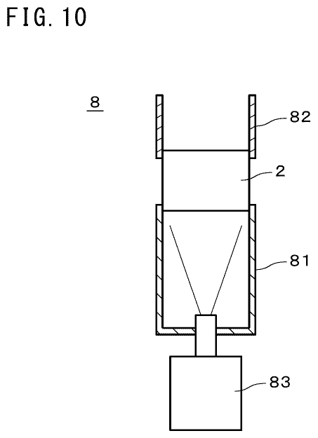

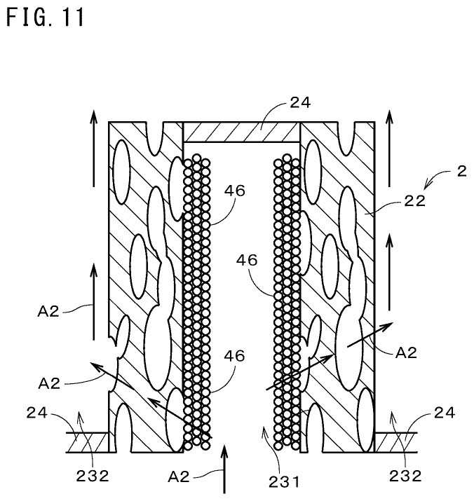

Next, a porous sintered body having air permeability is prepared as the base material 2 (step S21). Any of various known methods may be used as the method of producing the base material 2. Then, a step of depositing the porous particles on the base material 2 is performed by a dry deposition method (step S22). FIG. 10 is a diagram showing a configuration of a dry deposition device 8. FIG. 11 is a diagram for describing a state in which porous particles 46 are deposited on the base material 2, and schematically shows part of a section of the base material 2 along the longitudinal direction.

The dry deposition device 8 shown in FIG. 10 includes a first tubular portion 81, a second tubular portion 82, and a particle supplier 83. The first tubular portion 81 and the second tubular portion 82 are both tubular members, and their sectional shapes perpendicular to their central axis are approximately the same as the sectional shape of the outer surface of the base material 2 (the outer surface of the tubular outer wall 21). As described previously, the base material 2 is a member that extends in the longitudinal direction, with its one longitudinal end inserted in the end portion of the first tubular portion 81 and its other longitudinal end inserted in the end portion of the second tubular portion 82. In the present embodiment, the end of the base material 2 at which the first cells 231 (see FIG. 11) are open (i.e., the end at which the second cells 232 have the mesh sealing parts 24) is inserted in the first tubular portion 81, and the end of the base material 2 at which the second cells 1232 are open is inserted in the second tubular portion 82. The outer surface of the base material 2 may come in contact with the first tubular portion 81 or the second tubular portion 82 via an O-ring or the like. Passage of gases and liquids is almost impossible between the outer surface of the base material 2 and the inner surface of the first tubular portion 81 and between the outer surface of the base material 2 and the inner surface of the second tubular portion 82.

The end of the first tubular portion 81 on the side opposite to the base material 2 is connected to the particle supplier 83. The particle supplier 83 supplies an aerosol in which the porous particles are dispersed in a gas, into the first tubular portion 81. A dispersion medium of the aerosol is, for example, air. The dispersion medium of the aerosol may be a gas other than air. The end of the second tubular portion 82 on the side opposite to the base material 2 is connected to a pressure-reducing mechanism which is not shown, so as to reduce pressure inside the second tubular portion 82. This allows the aerosol supplied into the first tubular portion 81 to flow into the base material 2.

As indicated by arrows A2 in FIG. 11, the aerosol flows into the first cells 231. The gas contained in the aerosol penetrates into the partition wall 22 from pores that are open to the inner surfaces of the first cells 231, and flows into the second cells 232 adjacent to the first cells 231. The gas flowing into the second cells 232 is exhausted to the outside of the base material 2 through the openings of the second cells 232. Accordingly, the porous particles 46 are deposited on the inner surfaces. At this time, in order to prevent most of the porous particles 46 from penetrating into the pores of the inner surfaces, the porous particles 46 preferably have a mean particle diameter of greater than or equal to the mean pore diameter of the base material 2. The mean pore diameter of the base material 2 is preferably greater than or equal to 10 μm and less than or equal to 30 μm, and the mean particle diameter of the porous particles 46 is preferably greater than or equal to 15 μm and less than or equal to 40 μm. The mean particle diameter is an arithmetical mean value (an arithmetical mean value obtained by dividing a total value of the diameters of particles by the number of particles, or a value equivalent thereto; the same applies below), and is obtained from the particle size distribution of particles obtained by a laser diffraction method.

Preferably, the density of the porous particles in the aerosol is higher than or equal to 0.2 g/cm³ and lower than or equal to 1.2 g/cm³, and the rate of suction of the aerosol is higher than or equal to 8.0 L/(min/cm²) and lower than or equal to 15 L/(min/cm²) (“L” represents the liter). The thickness of a sedimentary layer of the porous particles is preferably greater than or equal to 25 μm and less than or equal to 50 μm. The thickness of the sedimentary layer is obtained as a difference between a mean place of the surface heights of the sedimentary layer and a mean place of the surface heights of the base material, which are measured by a three-dimensional shape measuring device using a laser.

The base material 2 with the porous particles 46 deposited thereon is taken out of the dry deposition device 8 and subjected to firing (step S23). In the case where the material particles are alumina particles, the heating temperature during firing is preferably higher than or equal to 800° C. and lower than or equal to 1500° C. The heating time during firing is preferably 0.5 hours or more and 5 hours or less. In the case where the material particles are silica particles, the heating temperature during firing is preferably higher than or equal to 600° C. and lower than or equal to 1200° C. The heating time during firing is preferably 0.5 hours or more and 5 hours or less. By this firing, the collection layer 3 is formed on the base material 2, and the porous complex 1 is acquired. A mean thickness of the collection layer 3 is preferably greater than or equal to 20 μm and less than or equal to 45 μm.

Note that in step S22, silicon carbide (SiC) particles may be mixed in the aerosol. This improves the adhesion of the porous particles 46 and the base material 2 during firing in step S23. A mean particle diameter of the silicon carbide particles is preferably greater than or equal to 0.1 μm and less than or equal to 10 μm, and the amount of mixture is preferably greater than or equal to 3 wt % and less than or equal to 30 wt % to a weight of the porous particles.

Next, Examples 1 to 7 of the porous complex according to the present invention and Comparative Examples 1 and 2 for comparison with this porous complex will be described with reference to Tables 1 to 3.

TABLE 1

| | | | |
|---|---|---|---|
| Inorganic | Pore-Forming | Pre-firing | Porous |
| Material | Material | Conditions | Particles |

| | | | Specific | | Mean | Pre- | Pre- | Mean | Specific |
|---|---|---|---|---|---|---|---|---|---|
| | | | Surface | | Particle | firing | firing | Particle | Surface |
| | | | Area | | Diameter | Temperature | Time | Diameter | Area * |
| | | Material | m²/g | Material | μm | ° C. | h | μm | m²/g |
| Example | 1 | Al₂O₃ | 300 | Polyethylene | 1 | 600 | 1 | 20 | 300 |
| Example | 2 | Al₂O₃ | 300 | Polyethylene | 1 | 600 | 1 | 25 | 300 |
| Example | 3 | Al₂O₃ | 300 | Polyethylene | 1 | 600 | 1 | 25 | 300 |
| Example | 4 | Al₂O₃ | 300 | Polyethylene | 1 | 600 | 1 | 30 | 280 |
| Example | 5 | Al₂O₃ | 300 | Polyethylene | 1 | 600 | 1 | 30 | 280 |
| Example | 6 | Al₂O₃ | 300 | Polyethylene | 1 | 600 | 1 | 30 | 320 |

| | | | Mean | | | Pre- | Pre- | Mean | Specific |
|---|---|---|---|---|---|---|---|---|---|
| | | | Particle | | Particle | firing | firing | Particle | Surface |
| | | | Diameter | | Diameter | Temperature | Time | Diameter | Area * |
| | | Material | nm | Material | μm | ° C. | h | μm | m²/g |
| Example | 7 | SiO₂ | 15 | Polyethylene | 3.5 | 600 | 1 | 30 | 80 |

* Specific surface area of porous particles are BET specific surface area of pre-fired particles.

TABLE 2

| | | Base Material | | | Collection-Layer Forming Conditions | | | | | | |
|---|---|---|---|---|---|---|---|---|---|---|---|
| | | | | Mean | | | Mean | | | | |
| | | | | Pore | | | Particle | | Suction | Firing | Firing |
| | | | Porosity | Diameter | Particle | | Diameter | Addition | Displacement | Temperature | Time |
| | | Material | % | μm | Form | Material | μm | of SiC | L/(min · cm²) | ° C. | h |
| Example | 1 | Cordierite | 48 | 12 | Porous | Al₂O₃ | 20 | Yes | 8.2 | 1150 | 2 |
| | | | | | Particles | | | | | | |
| Example | 2 | Cordierite | 48 | 12 | Porous | Al₂O₃ | 25 | Yes | 11.0 | 1150 | 2 |
| | | | | | Particles | | | | | | |
| Example | 3 | Cordierite | 48 | 12 | Porous | Al₂O₃ | 25 | Yes | 11.0 | 1150 | 2 |
| | | | | | Particles | | | | | | |
| Example | 4 | Cordierite | 48 | 12 | Porous | Al₂O₃ | 30 | Yes | 11.0 | 1100 | 2 |
| | | | | | Particles | | | | | | |
| Example | 5 | Cordierite | 48 | 12 | Porous | Al₂O₃ | 30 | Yes | 11.0 | 1100 | 2 |
| | | | | | Particles | | | | | | |
| Example | 6 | Cordierite | 48 | 12 | Porous | Al₂O₃ | 30 | Yes | 11.0 | 1000 | 2 |
| | | | | | Particles | | | | | | |
| Example | 7 | Cordierite | 48 | 12 | Porous | SiO₂ | 30 | No | 11.0 | 1000 | 1.5 |
| | | | | | Particles | | | | | | |
| Comparative | 1 | Cordierite | 48 | 12 | Solid | Al₂O₃ | 0.1 | No | 13.7 | 1100 | 1.5 |
| Example | | | | | Particles | | | | | | |
| Comparative | 2 | Cordierite | 48 | 12 | Solid | Al₂O₃ | 0.1 | No | 13.7 | 1100 | 1.5 |
| Example | | | | | Particles | | | | | | |

TABLE 3

| | | Collection Layer | | | | | | | | |
|---|---|---|---|---|---|---|---|---|---|---|
| | | | Penetration | | | Mean | | | | |
| | | | Depth into | | Mean | Maximum | Mean | | | Initial |
| | | | Base | | Pore | Pore | Membrane | SiC | Collection | Pressure |
| | | | Material | Porosity | Diameter | Size | Thickness | Content | Efficiency | Loss |
| | | Material | μm | % | μm | μm | μm | wt % | % | % |
| Example | 1 | Al₂O₃ | 5 | 76 | 0.5 | 1.5 | 35 | 5 | 99.9 | 55 |
| Example | 2 | Al₂O₃ | 5 | 78 | 0.7 | 1.7 | 35 | 10 | 99.7 | 53 |
| Example | 3 | Al₂O₃ | 0 | 82 | 0.9 | 2.7 | 40 | 0 | 99.2 | 42 |
| Example | 4 | Al₂O₃ | 0 | 82 | 0.9 | 2.7 | 36 | 10 | 99.3 | 40 |
| Example | 5 | Al₂O₃ | 0 | 90 | 1.1 | 3.0 | 36 | 10 | 98.5 | 30 |
| Example | 6 | Al₂O₃ | 5 | 92 | 1.3 | 4.0 | 35 | 15 | 98.0 | 29 |
| Example | 7 | SiO₂ | 0 | 82 | 1.0 | 3.0 | 40 | 0 | 99.5 | 40 |
| Comparative | 1 | Al₂O₃ | 20 | 86 | 1.7 | — | 14 | 0 | 99.8 | 100 |
| Example | | | | | | | | | | |
| Comparative | 2 | Al₂O₃ | 20 | 86 | 0.8 | 2.5 | 50 | 10 | 99.8 | 95 |
| Example | | | | | | | | | | |

### EXAMPLE 1

In the generation of the porous particles according to Example 1, alumina particles were used as inorganic material particles, and commercial polyethylene particles were used as pore-forming materials. The alumina particles were obtained in the form of a commercial alumina sol.

The alumina particles in the sol had a specific surface area of 300 m²/g (a catalog value measured by a mercury porosimeter after heat treatment conducted at 500° C. for one hour), and the polyethylene particles had a mean particle diameter of 1 μm (catalog value). Aggregates of intermediate particles were generated by spray drying conducted in an environment at a temperature of 80° C. and then pre-fired at 600° C. for one hour to obtain a porous intermediate. The porous intermediate was subjected to disintegration and classification to obtain porous particles with a mean particle diameter of 20 μm and a specific surface area of 300 m²/g. The specific surface area of the porous particles was a BET specific surface area (the same applies below).

Next, a base material formed of cordierite and having a honeycomb filter shape (honeycomb structure) was prepared. The base material had a porosity of 48% and a mean pore diameter of 12 μm (an arithmetical mean value obtained by dividing a total value of the diameters of all pores by the number of pores, or a value equivalent thereto; the same applies below). The porosity was measured by the Archimedes method using deionized water as a medium. The mean pore diameter was measured by a mercury porosimeter.

The aforementioned porous particles were deposited on the base material of cordierite by a dry deposition method. During the deposition, suction was conducted at 8.2 L/(min cm²) (the amount of suction per unit time of one minute and per unit surface area of 1 cm² in the first cells 231 of the base material 2). At this time, silicon carbide (SiC) powder was mixed with the porous particles. Thereafter, firing was conducted at a temperature of 1150° C. for two hours to form a collection layer.

In the produced porous complex, the penetration depth of the collection layer into the pores of the base material in a longitudinal section of the collection layer of alumina, i.e., in a section of the porous complex along a plane perpendicular to the surface of the base material, was 5 μm, and the collection layer had a porosity of 76%, a mean pore diameter of 0.5 μm, a mean maximum pore size of 1.5 μm, and a mean membrane thickness (i.e., mean layer thickness) of 35 μm. The silicon carbide content in the collection layer was 5 wt %.

These measured values were obtained from a 1000× SEM (scanning electron microscope) image acquired by embedding a fragment of the porous complex in a resin and subjecting a section of the fragment to mirror polishing. Specifically, the “penetration depth of the collection layer into the pores of the base material” was obtained by drawing a curve that was assumed to be the surface of the base material in the SEM image, acquiring a straight line that best fitted this curve by the least squares method or any other method, and obtaining a mean penetration depth of the collection layer into the pores with respect to this straight line. The “porosity of the collection layer” was obtained by image analysis of the SEM image using Image-Pro described above. This image analysis is conducted by, for example, a technique similar to that used in International Publication WO2020/194681 described above. Specifically, in a region of the SEM image where the collection layer existed, the areas of bright regions where bright portions (i.e., a skeleton part of the collection layer) appeared and the areas of dark regions where dark portions (i.e., the pores of the collection layer) appeared were calculated. Then, a total area of the dark regions was divided by a sum of a total area of the bright regions and the total area of the dark regions to calculate the porosity of the collection layer.

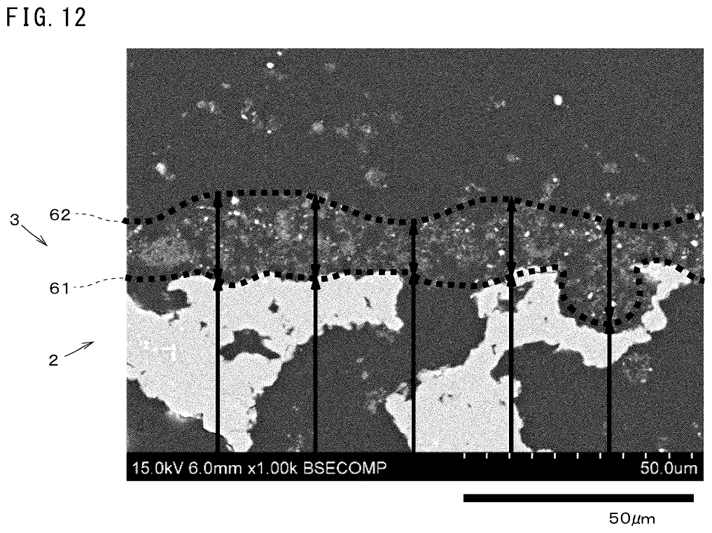

The “mean pore diameter of the collection layer” was obtained by binarizing the SEM image by using Image-Pro with a threshold value that allowed a distinction between the skeleton of the network structure and the sections of pores, acquiring the contours of a large number of pores from this image, and obtaining an arithmetical mean value of the widths of portions where the pores were connected to one another. The “mean maximum pore size of the collection layer” was obtained by acquiring the contours of a large number of pores from the binarized SEM image described above and obtaining an arithmetical mean value of the major axes of ellipses that best fitted each contour (ellipses that had the smallest difference area from the contour). The “mean membrane thickness of the collection layer” was obtained by, as shown in FIG. 12, acquiring a curve 61 that followed the boundary between the surface of the base material 2 and the collection layer 13 and a curve 62 that followed the surface of the collection layer 3, and obtaining an arithmetical mean value of the distances between the two curves 61 and 62 measured on straight lines that divided the image into six equal parts in the right-and-left direction. Note that the right-left direction of the image was the direction along the surface of the base material 2. In various measurements, a sample did not necessarily have to be embedded in a resin, and similar observations and measurements were possible even if the sample was not embedded in a resin.

Unless otherwise specified, the methods of acquiring the above-described measured values for the base material and the collection layer were also applied to the examples and the comparative examples described below.

In Example 1, the collection efficiency of the porous complex was 99.9%, and the rate of rise in initial pressure loss was 55%.

The collection efficiency of the porous complex was obtained as follows. Firstly, the porous complex was mounted as a GPF on an exhaust system of a passenger vehicle that included a 2-liter direct injection gasoline engine, and a chassis dynamometer vehicle test was conducted. In the vehicle test, the number of exhausted pieces of particulate matter contained in an exhaust gas exhausted during driving in a driving mode of Europe regulations (RTS95) was measured by a measurement method according to the PMP (particulate measurement protocol of European regulations). The same vehicle test was also conducted without a GPF mounted on the aforementioned exhaust system, and the number of exhausted pieces of particulate matter contained in an exhaust gas was measured by the same measurement method. With the number of exhausted pieces of particulate matter without a GPF assumed as a “reference number of exhausted pieces”, “collection efficiency (%)” was defined as a value (%) obtained by dividing a difference between the number of exhausted pieces of particulate matter measured with the porous complex mounted on the system and the reference umber of exhausted pieces, by the reference number of exhausted pieces.

In an assessment on the initial pressure loss of the porous complex, firstly, air at ambient temperature was supplied to the porous complex at a flow rate of 10 Nm³/min, and a pressure difference before and after the supply in the porous complex (i.e., a differential pressure between on the air inflow and outflow sides) was measured. Then, the pressure difference in the case where there was only the base material was assumed as a reference pressure difference, and the rate of increase in the aforementioned pressure difference of the porous complex with respect to the reference pressure difference was determined as the rate of increase in initial pressure loss. This rate of increase (%) in initial pressure loss was obtained from (A−B)/B×100, where A was the aforementioned pressure difference of the porous complex, and B was the reference pressure difference of the base material. The way of obtaining the collection efficiency and the initial pressure loss were the same as in Examples 2 to 7 and Comparative Examples 1 and 2 described below.

### EXAMPLE 2

Conditions for generating the porous particles according to Example 2 were the same as in Example 1, except that the obtained porous particles had a mean particle diameter of 25 μm and a specific surface area of 300 m²/g.

Baking of the porous particles onto the base material was the same as in Example 1, except that suction displacement during deposition of the porous particles on the base material was 11.0 L/(min cm²).

In the produced porous complex, the penetration depth of the collection layer into the pores of the base material in a longitudinal section of the collection layer of alumina was 5 μm, and the collection layer had a porosity of 78%, a mean pore diameter of 0.7 μm, a mean maximum pore size of 1.7 μm, and a mean membrane thickness of 35 μm. The silicon carbide content in the collection layer was 10 wt %.

In Example 2, the collection efficiency of the porous complex was 99.7%, and the rate of rise in initial pressure loss was 53%.

### EXAMPLE 3

Conditions for generating the porous particles and the results of measuring the porous particles according to Example 3 were the same as in Example 2.

Baking of the porous particles on the base material was the same as in Example 2, except that silicon carbide powder was not mixed with the porous particles during deposition of the porous particles on the base material.

In the produced porous complex, the penetration depth of the collection layer into the pores of the base material in a longitudinal section of the collection layer of alumina was 0 μm, and the collection layer had a porosity of 82%, a mean pore diameter of 0.9 μm, a mean maximum pore size of 2.7 μm, and a mean membrane thickness of 40 μm. The silicon carbide content in the collection layer was 0 wt %.

In Example 3, the collection efficiency of the porous complex was 99.2%, and the rate of rise in initial pressure loss was 42%.

### Example 4

Conditions for generating the porous particles according to Example 4 were the same as in Example 1, except that the obtained porous particles had a mean particle diameter of 30 μm and a specific surface area of 280 m²/g.

Conditions for backing the porous particles on the base material were the same as in Example 2, except that the firing temperature was 1100° C.

In the produced porous complex, the penetration depth of the collection layer into the pores of the base material in a longitudinal section of the collection layer of alumina was 0 μm, and the collection layer had a porosity of 82%, a mean pore diameter of 0.9 μm, a mean maximum pore size of 2.7 μm, and a mean membrane thickness of 36 μm. The silicon carbide content in the collection layer was 10 wt %.

In Example 4, the collection efficiency of the porous complex was 99.3%, and the rate of rise in initial pressure loss was 40%.

### EXAMPLE 5

Conditions for generating the porous particles and the results of measuring the porous particles according to Example 5 were the same as in Example 4. Conditions for baking the porous particles on the base material were also the same as in Example 4.

In the produced porous complex, the penetration depth of the collection layer into the pores of the base material in a longitudinal section of the collection layer of alumina was 0 μm, and the collection layer had a porosity of 90%, a mean pore diameter of 1.1 μm, a mean maximum pore size of 3.0 μm, and a mean membrane thickness of 36 μm. The silicon carbide content in the collection layer was 10 wt %.

In Example 5, the collection efficiency of the porous complex was 98.5%, and the rate of rise in initial pressure loss was 30%.

### EXAMPLE 6

Conditions for generating the porous particles according to Example 6 were the same as in Example 4, except that the obtained porous particles had a mean particle diameter of 30 μm and a specific surface area of 320 m²/g. Conditions for baking the porous particles on the base material were the same as in Example 4, except that the firing temperature was 1000° C.

In the produced porous complex, the penetration depth of the collection layer into the pores of the base material in a longitudinal section of the collection layer of alumina was 5 μm, and the collection layer had a porosity of 92%, a mean pore diameter of 1.3 μm, a mean maximum pore size of 4.0 μm, and a mean membrane thickness of 35 μm. The silicon carbide content in the collection layer was 15 wt %.

In Example 6, the collection efficiency of the porous complex was 98.0%, and the rate of rise in initial pressure loss was 29%.

### EXAMPLE 7

In the generation of the porous particles according to Example 7, silica particles were used as inorganic material particles, and commercial polyethylene particles were used as pore-forming materials. The silica particles were obtained in the form of commercial colloidal silica.

The silica particles in colloidal silica had a mean particle diameter of 15 nm (a catalog value obtained, for example, from a TEM (transmission electron microscope) observation image after colloidal silica was subjected to drying), and the polyethylene particles had a mean particle diameter of 3.5 μm (catalog value). Aggregates of intermediate particles were generated by spray drying and pre-fired at 600° C. for one hour to acquire a porous intermediate. The porous intermediate was subjected to disintegration to acquire porous particles with a mean particle diameter of 30 μm and a specific surface area of 80 m²/g. The specific surface area of the porous particles is a BET specific surface area.

Next, a base material of cordierite similar to that in Example 1 was prepared, and the aforementioned porous particles were deposited on the base material by a dry deposition method. During deposition, suction was conducted at 11 L/(min cm²). At this time, silicon carbide powder was not mixed with the porous particles. Thereafter, firing was conducted at a temperature of 1000° C. for 1.5 hours to form a collection layer.

In the produced porous complex, the penetration depth of the collection layer into the pores of the base material in a longitudinal section of the collection layer of silica was 0 μm, and the collection layer had a porosity of 82%, a mean pore diameter of 1.0 μm, a mean maximum pore size of 3.0 μm, and a mean membrane thickness of 40 μm. The silicon carbide content in the collection layer was 0 wt %.

In Example 7, the collection efficiency of the porous complex was 99.5%, and the rate of rise in initial pressure loss was 40%.

### Comparative Example 1

In the production of the porous complex according to Comparative Example 1, solid alumina particles were used, instead of the porous particles in Example 1. The material, porosity, and mean pore diameter of the base material were the same as in Example 1. The alumina particles had a mean particle diameter of 0.1 μm (catalog value), and suction was conducted at 13.7 L/(min cm²) during deposition of the alumina particles on the base material by a dry deposition method. At this time, silicon carbide powder was not mixed with the alumina particles. Thereafter, firing was conducted at a temperature of 1100° C. for 1.5 hours to form a collection layer.

In the produced porous complex, the penetration depth of the collection layer into the pores of the base material in a longitudinal section of the collection layer of alumina was 20 μm, and the collection layer had a porosity of 86%, a mean pore diameter of 1.7 μm, and a mean membrane thickness of 14 μm. The silicon carbide content in the collection layer was 0 wt %.

In Comparative Example 1, the collection efficiency of the porous complex was 99.8%, and the rate of rise in initial pressure loss was 100%.

### Comparative Example 2

The production of the porous complex according to Comparative Example 2 was the same as in Comparative Example 1, except that silicon carbide powder was mixed with the alumina particles during deposition of the alumina particles on the base material.

In the produced porous complex, the penetration depth of the collection layer into the pores of the base material in a longitudinal section of the collection layer of alumina was 20 μm, and the collection layer had a porosity of 86%, a mean pore diameter of 0.8 μm, a mean maximum pore size of 25 μm, and a mean membrane thickness of 50 μm. The silicon carbide content in the collection layer was 10 wt %.

In Comparative Example 2, the collection efficiency of the porous complex was 99.8%, and the rate of rise in initial pressure loss was 95%.

As is clear from the examples and the comparative examples described above, the porous complex according to the present invention can suppress a rise in pressure loss because the collection layer has a dense foam network structure. If the collection layer is formed by simply baking the alumina particles on the base material as in Comparative Examples 1 and 2, the collection layer will penetrate into the pores, resulting in an increase in initial pressure loss. Note that the reduction in initial pressure loss shown in the examples further results in a reduction in pressure loss in a state where particulate matter has been collected by the collection layer.

The “air permeability” of the porous complex 1 according to the present invention refers to the property of allowing gases to flow from one surface of the porous complex 1 to the other surface thereof through the internal pores when a pressure difference is applied between the one surface of the porous complex 1 and the other surface thereof on the opposite side. Therefore, the base material 2 and the collection layer 3 also naturally have air permeability. The base material 2 and the collection layer 3 are both porous sintered bodies. The base material 2 is not limited to cordierite and may, for example, be Si-bonded SiC, Cd-bonded SiC, Si₃N₄-bonded SiC, silicon carbide, silicon nitride (Si₃N₄), alumina, mullite or the like. From the viewpoint of exhibiting high heat resistance, the collection layer 3 is preferably alumina, but is not limited to alumina and may be silica, cordierite, silicon carbide, mullite or the like described above. However, in order for the collection layer 3 to achieve its function of collecting particulate matter, the mean pore diameter of the collection layer 3 is smaller than the mean pore diameter of the base material 2.

In particular, in the case where the porous complex 1 is used as a particle filter for an exhaust gas or the like, the mean pore diameter of the base material 2 is preferably greater than or equal to 10 μm and less than or equal to 30 μm. This allows the porous complex to suppress the penetration of the collection layer 3 into the pores while achieving satisfactory air permeability.

On the other hand, in Examples 1 to 7 described above, the collection layer 3 with the network structure had a porosity of higher than or equal to 76% and lower than or equal to 92% and a mean pore diameter of greater than or equal to 0.5 μm and less than or equal to 1.3 μm. It can be found from these values that, in order to maintain the efficiency of collecting particulate matter while maintaining air permeability, the collection layer 3 preferably has a porosity of higher than or equal to 75% and lower than or equal to 95% and a mean pore diameter of greater than or equal to 0.3 μm and less than or equal to 1.5 μm, and more preferably has a porosity of higher than or equal to 80% and lower than or equal to 90% and a mean pore diameter of greater than or equal to 0.8 μm and less than or equal to 1.2 μm. Note that the “mean pore diameter of the collection layer 3” refers to an arithmetical mean value of the diameters of the pores of the collection layer 3 or a value equivalent thereto. The same applies to the base material 2.

In order to suppress the penetration of the collection layer 3 into the pores of the base material 2, the porous particles 46 that are deposited on the base material 2 during formation of the collection layer 3 preferably have a mean particle diameter of greater than or equal to the mean pore diameter of the base material 2. It is, however, noted that even if the mean particle diameter of the porous particles 46 is less than the mean pore diameter of the base material 2, the porous particles 46 may not penetrate into the pores of the base material 2, and even if the mean particle diameter of the porous particles 46 is approximately one half of the mean pore diameter of the base material 2, it is possible to suppress the penetration of the porous particles 46 into the pores. Thus, the mean particle diameter of the porous particles 46 may only be greater than or equal to 15 μm. If the porous particles 46 have a too large mean particle diameter, large clearances will be formed between the porous particles 46 during deposition, resulting in deterioration in uniformity of the collection layer 3. Thus, the mean particle diameter of the porous particles 46 is preferably less than or equal to 40 μm.

The penetration depth of the collection layer 3 into the base material 2 is preferably less than or equal to 10 μm. In order to also suppress a rise in pressure loss while suppressing deterioration in collection efficiency, the mean membrane thickness of the collection layer 3 is preferably greater than or equal to 20 μm and less than or equal to 45 μm.

The collection layer 3 provided on the base material 2 exhibits a dense foam network structure in a longitudinal section. The “dense foam network structure” refers to a state in which traces of the pore-forming materials 42 that are densely gathered and present before pre-firing is still remaining, and thin skeletons are connected to form a continuous space by connection of spaces where the pore-forming materials 42 were present. Such a structure can also be regarded as a sponge-or foam-like structure (with no flexibility). Note that the collection layer 3 “exhibits” a dense foam network structure in a “longitudinal section” and the expression of the “dense foam network structure” is merely used to express the actual structure.

In the intermediate particles 44 generated before generation of the porous particles 46, material particles for forming the collection layer 3 (in the case of FIG. 9B, the alumina particles 41) are present between the densely gathered pore-forming materials 42. The “densely gathered pore-forming materials” refer to a state in which the distances between the pore-forming materials 42 are shorter than the diameter of the pore-forming materials 42 or a state in which the pore-forming materials 42 are in contact with one another, and at least the material particles are present between the pore-forming materials 42 in the intermediate particles 44. Of course, the material particles may also be present in regions other than the spaces between the pore-forming materials 42. The aggregates of the intermediate particles 44 before pre-firing refer to, for example, the intermediate particles 44 that are deposited at predetermined positions by spray drying. The aggregates of the intermediate particles 44 may further be in such a state that they are collected and placed in a mold.

The “pre-firing” refers to firing the intermediate particles 44 at a temperature lower than or equal to the temperature at which the porous particles 46 are baked on the base material 2. It is known that the network structure will deteriorate if the intermediate particles 44 are fired at temperatures higher than necessary.

The mean particle diameter of the pore-forming materials 42 has direct influence on the denseness of the network structure of the collection layer 3 and affects collection efficiency and pressure loss. Since the mean particle diameters of the pore-forming materials in the examples were 1 μm and 3.5 μm, the mean particle diameter of the pore-forming materials 42 is preferably greater than or equal to 500 nm and less than or equal to 10 μm in order to achieve a preferable relationship between collection efficiency and pressure loss. The pore-forming materials 42 to be used may be obtained by mixing pore-forming materials having different mean particle diameters. The material for the pore-forming materials 42 may also be other than polyethylene, and may be starch, a polymethyl methacrylate resin, a phenol resin or the like. The shape of the pore-forming materials 42 is not limited to a spherical shape, and may be a granular shape, a fiber shape, a plate-like shape or the like.

Regarding the material particles, since the specific surface area of the alumina particles in Examples 1 to 6 were 300 m²/g, it is conceivable that a preferable range of the specific surface area of the material particles is at least greater than or equal to 150 m²/g and less than or equal to 400 m²/g. Since the mean particle diameter of the silica particles in Example 7 was 15 nm and the mean particle diameter of the material particles may only be smaller enough than the mean particle diameter of the pore-forming materials, it is conceivable that a preferable range of the mean particle diameter of the material particles is at least greater than or equal to 10 nm and less than or equal to 50 nm.

The “deposition” of the porous particles 46 on the base material 2 during formation of the collection layer 3 refers to a state in which the particles are simply stacked one above another without any adhesive or the like, and a different method other than the method using the dry deposition device 8 described above may be adopted for the deposition of the porous particles 46. For example, the porous particles 46 may be deposited on the base material 2 by simply using gravity or centrifugal force, or may be deposited by any other physical force. The amount of deposition of the porous particles 46 has direct influence on the mean membrane thickness of the collection layer 3. Considering that the volume of the porous particles 46 does not change significantly during baking due to pre-firing of the porous particles 46, the porous particles 46 are preferably deposited to a thickness of greater than or equal to 25 μm and less than or equal to 50 μm on the base material 2.

Note that the various “preferable” numerical ranges given in the above description do not intend to limit the present invention.

The application of the porous complex 1 is not limited to a gasoline particulate filter that collects particulate matter contained in an exhaust gas exhausted from a gasoline engine. For example, the porous complex 1 may be used as a diesel particulate filter (DPF) that collects particulate matter contained in an exhaust gas exhausted from a diesel engine. The porous complex 1 is also applicable in other applications for collecting particulate matter contained in a gas. Since the collection of particulate matter refers to separation of a gas and particulate matter, the porous complex 1 may also be used in various other applications for separating a gas and particulate matter. Moreover, the characteristic structure of the collection layer according to the present invention may possibly be used in various other applications other than the collection or separation of particulate matter.

The structure of the porous complex 1 may be modified in various ways. For example, the mesh sealing parts 24 may be omitted from the base material 2. Alternatively, the inner surfaces of all of the cells 23 may be used as the collection surfaces, and the collection layer 3 may be provided on these collection surfaces. As yet another alternative, the base material 2 does not necessarily have to have a honeycomb structure, and may have any other shape whose interior is not partitioned by partitional walls, such as a simple tubular or flat plate-like shape. The porous complex 1 does not necessarily have to be a single independent member, and may be part of one member.

The configurations of the above-described preferred embodiment and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

### REFERENCE SIGNS LIST

1 porous complex
2 base material
3 collection layer
40 droplets
41 alumina particles (material particles)
42 pore-forming material
44 intermediate particles
45 porous intermediate
46 porous particles
S11 to S13, S21 to S23 step

1. A porous complex comprising:
a base material that is a porous sintered body having air permeability; and
a collection layer that is a sintered body provided on said base material and having air permeability, said collection layer exhibiting a dense foam network structure in a longitudinal section, wherein
said collection layer has a porosity of higher than or equal to 75% and lower than or equal to 95% and a mean pore diameter of greater than or equal to 0.3 μm and less than or equal to 1.5 μm.

2. The porous complex according to claim 1, wherein
said base material has a mean pore diameter of greater than or equal to 10 μm and less than or equal to 30 μm.

3. The porous complex according to claim 1, wherein
said collection layer has a mean membrane thickness of greater than or equal to 20 μm and less than or equal to 45 μm.

4. The porous complex according to claim 1, wherein
said collection layer is formed of alumina.

5. The porous complex according to claim 1, wherein
said collection layer contains silicon carbide, and said base material is cordierite.

6. The porous complex according to claim 1,
the porous complex being a particulate filter that collects particulate matter contained in an exhaust gas exhausted from a gasoline engine or a diesel engine.

7. A method of producing a porous complex, comprising:
a) generating an aggregate of intermediate particles by drying droplets that contain pore-forming materials and material particles smaller than said pore-forming materials, said intermediate particles being particles where said material particles are present between said pore-forming materials that are densely gathered;
b) forming a porous intermediate by pre-firing the aggregate of said intermediate particles;
c) obtaining porous particles by disintegration of said porous intermediate;
d) preparing a base material that is a porous sintered body having air permeability;
e) depositing said porous particles on said base material; and
f) forming a collection layer on said base material by firing said porous particles.

8. The method of producing a porous complex according to claim 7, wherein
said pore-forming materials have a mean particle diameter of greater than or equal to 500 nm and less than or equal to 10 μm, and
said material particles have a specific surface area of higher than or equal to 150 m²/g and lower than or equal to 400 m²/g or a mean particle diameter of greater than or equal to 10 nm and less than or equal to 50 nm.

9. The method of producing a porous complex according to claim 7, wherein
said base material has a mean pore diameter of greater than or equal to 10 μm and less than or equal to 30 μm, and
said porous particles have a mean particle diameter of greater than or equal to 15 μm and less than or equal to 40 μm.

10. The method of producing a porous complex according to claim 9, wherein
in said operation e), said porous particles are deposited to a thickness of greater than or equal to 25 μm and less than or equal to 50 μm on said base material.

11. The method of producing a porous complex according to claim 7, wherein
said material particles are alumina particles.
